(19) United States
(12) Patent Application Publication
(10) Pub. No.: US 2010/0115039 A1
(43) Pub. Date: May 6, 2010

(54) COMMUNICATION SYSTEM, COMMUNICATION SERVER, COMMUNICATION TERMINAL, AND COMMUNICATION METHOD FOR RECOMMENDING COMMUNICATION TOOL

(76) Inventors: Yeo-jin KIM, Suwon-si (KR); Hyun-joo KANG, Suwon-si (KR); Young-ho RHEE, Seoul (KR); Ju-youn LEE, Seongnam-si (KR); Il-ku CHANG, Seoul (KR)

Correspondence Address: North Star Intellectual Property Law, PC, P.O. Box 34688, Washington, DC, 20043, US

(21) Appl. No.: 12/557,639

(22) Filed: Sep. 11, 2009

(30) Foreign Application Priority Data
Oct. 31, 2008 (KR) 10-2008-0108034

(51) Int. Cl. G06F 15/16

(52) U.S. Cl. 709/206

(57) ABSTRACT

A communication system and a communication method of recommending a communication tool based on a state of a counter party are provided. In the communication system a server may be connected with at least one terminal over a network. The server may estimate a current state of a user of a first terminal from an expanding profile received from the first terminal and recommend a communication tool corresponding to the current state. A second terminal may receive the current state of the user of the first terminal and a recommended communication tool from the server. Accordingly, it is possible to perform communication according to the state of a counter party.

### CROSS-REFERENCE TO RELATED APPLICATION(S)

This application claims the benefit under 35 U.S.C. §119(a) of a Korean Patent Application No. 10-2008-108034, filed Oct. 31, 2008, the disclosure of which is incorporated by reference in its entirety for all purposes.

### BACKGROUND

1. Field

The following description relates to a technology to estimate a current state of a terminal user and provide a communication tool appropriated corresponding to the state.

2. Description of the Related Art

With the rapid development of information communication technology, devices equipped with various communication functionalities have been developed. Furthermore, as networks have been expanded and social networking services (SNS) have been provided, a need has arisen to share a variety of data between various devices having different communication functionalities.

For example, registered users share interests and/or activities through messenger programs running on computers. In this case, the user typically selects a buddy from a buddy list provided by the messenger program to initiate communication with another user.

However, the conventional buddy list is limited to displaying only the name and ID corresponding to the buddies, but not a present state of the buddies. That is, it cannot be seen from the buddy list whether or not a counter party will receive a message.

Accordingly, knowing a current state of a counter party would enable more effective communication. For example, where a counter party is known to be in conference or meeting, a simple text message would be more effective than a voice or telephonic call, since the counter party most likely would not appreciate being interrupted.

### SUMMARY

In one general aspect, there is provided a communication system, including a server and at least one terminal interconnected with the server over a network, wherein the server estimates a current state of a user of a first terminal from an expanding profile received from the first terminal and recommends a communication tool corresponding to the current state, and a second terminal receives the current state of the user of the first terminal and a recommended communication tool from the server and displays the current state of the user of the first terminal and the recommended communication tool.

The expanding profile may include at least one of a personal profile of the user and state data of the first terminal.

The state data may include at least one of type of a terminal, an on and/or off state of a power supply, an application in use, and a length of time and/or a location in use.

The first terminal (and/or the second terminal) may be one of a mobile phone, an Internet protocol television (IPTV), a portable multimedia player (PMP), a personal digital assistant (PDA), a camera, an MP3 player, a navigator, and a personal computer (PC).

Terminals of the same user may share the expanding profile in a same format.

In another general aspect, there is provided a server interconnected with at least one terminal over a network, including a database to store an expanding profile received from the terminal, a context analyzer configured to estimate a current state of a user of the terminal from the expanding profile, and a communication tool recommender configured to recommend a communication tool corresponding to the current state based on the estimated current state.

The expanding profile may include at least one of a personal profile of the user and state data of the terminal.

The state data may include at least one of a type of a terminal, an on and/or off state of a power supply, an application in use, and a length of time and/or a location in use.

The expanding profile may be registered with the database based on a user.

The server may provide the estimated current state and the recommended communication tool to another terminal.

The server may provide the estimated current state and the recommended communication tool only to users designated as buddies authorized to share data.

In still another general aspect, there is provided a terminal interconnected with a server over a network, including a profile manager configured to collect and send an expanding profile to the server, a display to receive a current state of a user of another terminal and a recommended communication tool corresponding to the current state from the server and display a list of buddies authorized to share data together with a current state of a corresponding buddy or a recommended communication tool in association with the buddy list, and a communicator configured to perform communication according to a communication tool selected by a user of the terminal among the recommended communication tools.

The terminal may be one of a mobile phone, an Internet protocol television (IPTV), a portable multimedia player (PMP), a personal digital assistant (PDA), a camera, an MP3 player, a navigator, and a personal computer (PC).

The expanding profile may include at least one of a personal profile of the user of the terminal and state data of the terminal.

The state data may include at least one of a type of a terminal, an on and/or off state of a power supply, an application in use, and a length of time and/or a location in use.

In response to performing communication according to the selected communication tool, the communicator may convert a voice signal into a text or vice versa where different types of terminals are communicated with each other.

In yet another general aspect, there is provided a communication method of a communication system including a server and at least one terminal interconnected with each other over a network, the method including collecting an expanding profile of a first terminal from the first terminal, estimating a current state of a user of the first terminal from the expanding profile and recommending a communication tool corresponding to the estimated current state, and providing the current state of the first terminal and the recommended communication tool to a second terminal.

The user of the first terminal and a user of the second terminal may be registered as buddies authorized to share data.

The first terminal and/or the second terminal may be one of a mobile phone, an Internet protocol television (IPTV), a portable multimedia player (PMP), a personal digital assistant (PDA), a camera, an MP3 player, a navigator, and a personal computer (PC).

The expanding profile may include at least one of a personal profile of the user of the first terminal and state data of the first terminal.

The state data may include a type of a terminal, an on and/or off state of a power supply, an application in use, and a length of time and/or a location in use.

In still yet another general aspect, there is provided a communication method of a communication system including a server and at least one terminal interconnected with each other over a network, the method including sending by a first terminal an expanding profile of the first terminal to the server, and receiving by the first terminal a current state of a user of a second terminal, which is generated based on an expanding profile of the second terminal, and a recommended communication tool from the server, and displaying the received current state of the user and the recommended communication tool.

In the displaying of the current state of the user, the first terminal may display a buddy list and the current state of the user of the second terminal and the recommended communication tool in association with the buddy list.

Other features and aspects will be apparent from the following description, the drawings, and the claims.

### BRIEF DESCRIPTION OF THE DRAWINGS

FIG. 1 is a diagram illustrating an exemplary communication system.

FIG. 2 is a block diagram illustrating an exemplary server.

FIG. 3 is a diagram illustrating an exemplary expanding profile.

FIG. 4 is a diagram illustrating an exemplary state analysis table.

FIG. 5 is a diagram illustrating an exemplary operation of a server.

FIG. 6 is a diagram illustrating an exemplary recommended communication tool.

FIG. 7 is a block diagram illustrating an exemplary terminal.

FIG. 8 is a diagram illustrating an exemplary display screen of a terminal.

FIG. 9 is a diagram illustrating another exemplary display screen of a terminal.

FIG. 10 is a flow chart illustrating an exemplary communication method.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions may be omitted for increased clarity and conciseness.

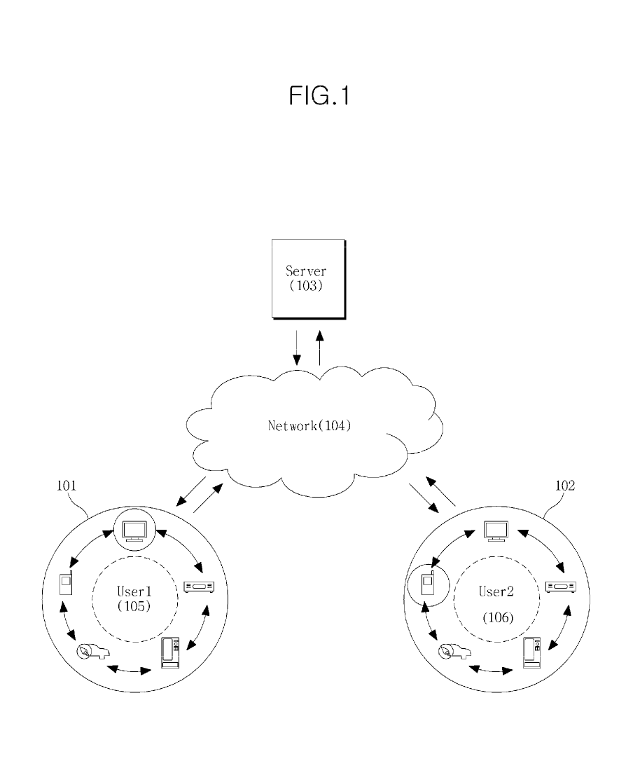

FIG. 1 illustrates an exemplary communication system.

Referring to FIG. 1, the communication system includes user terminals 101 and 102 and a server 103, which are interconnected with each other over a network 104.

Examples of the user terminals 101 and 102 may include a mobile phone, an Internet protocol television (IPTV), a portable multimedia player (PMP), a personal digital assistant (PDA), a camera, an MP3 player, a navigator, and a personal computer, but the user terminals 101 and 102, and the user terminal described herein, are not limited thereto.

The server 103 may receive data from the user terminals 101 and 102 and estimate current states of users 105 and 106 based on the received data. The server 103 may recommend a communication tool in view of the estimated state and provide the communication tool to each of the users 105 and 106.

For example, the terminals 101 of USER1 105 transmit an expanding profile to the server 103 over the network 104. The expanding profile may include a personal profile (e.g., name, ID, photo) of USER1 105 and state data (e.g., type of a terminal, an on and/or off state of a power supply, applications in use, and a length of time or location in use) of the terminals 101. Furthermore, the expanding profile in each of a plurality of various terminals may be configured in an identical format and thus be shared between terminals of the same user.

The server 103 may analyze the expanding profile and estimate the current state of USER1 105. For example, if a mobile phone and a navigator of USER1 105 are turned on and are determined to operate on a road, USER1 105 may be assumed to be driving. The server 103 recommends a communication tool based on USER1's current state to USER2 106. Examples of the communication tool include a communication device and a communication mode during communication. For example, if USER1 105 is driving, a navigator and a voice communication may be recommended as a communication tool instead of text messaging through a mobile phone.

Each terminal 102 of USER2 106 may receive data on the current state corresponding to USER1 105 and a recommended communication tool from the server 103 and display the data. For example, if USER2 106 desires to use his or her mobile phone, the mobile phone may be configured to display personal data of USER1 105 from a buddy list and display the current state of USER1 105 and the recommended communication tool in association with the buddy list.

In this case, USER2 106 may select a navigator as a communication device and a voice communication as a communication mode to initiate communication with USER1 105 who is driving.

On the other hand, if communication parties use different types of terminals (e.g., a mobile phone and a navigator) to communicate with each other, each of the terminals may be configured to convert voice signals into texts or vice versa. That is, even if USER2 106 enters a text message to his or her mobile phone, the text message may be converted into a voice to allow USER1 105 to hear the voice through his or her navigator.

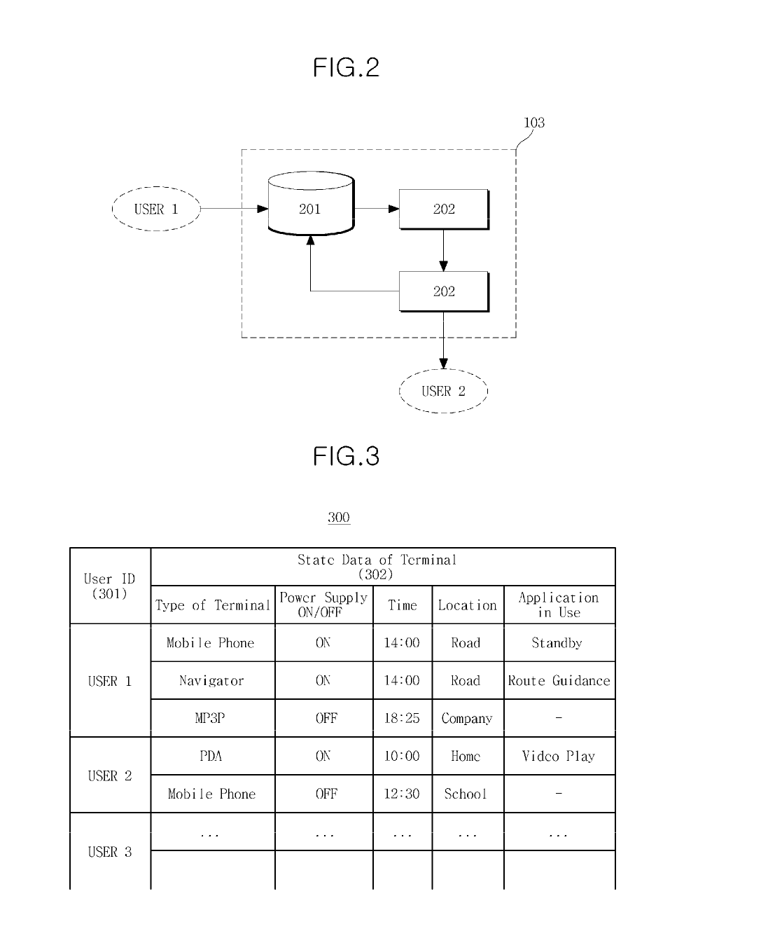

FIG. 2 illustrates an exemplary server 103.

Referring to FIG. 2, the server 103 includes a database 201, a context analyzer 202, and a communication tool recommender 203. The server 103 may be configured to receive an expanding profile from a user terminal, estimate a current state of a user, and recommend a communication tool corresponding to the state. Accordingly, the data on the user's current state and the recommended communication tool may be provided to the terminal over the network and displayed on the terminal.

The database 201 stores expanding profiles from each terminal. The term expanding profile refers to a personal profile (e.g., name, ID, photo) regarding a user and state data (e.g., a type of a terminal, an on and/or off state of a power supply, applications in use, a length of time or location in use) on a terminal, as described above. Since a single user may use multiple terminals, expanding profiles received from each terminal may be registered and managed based on each individual user.

The context analyzer 202 uses the expanding profile stored in the database 201 to estimate a current state of a user. For example, referring back to FIG. 1, where it is determined from an expanding profile associated with USER1 105 that a PDA is turned on in a conference room and a schedule editor is running on the PDA, USER1 105 may be estimated to be in a conference.

The communication tool recommender 203 recommends a communication tool corresponding to the current state. The communication tool may be a communication device (e.g., type of a communication terminal) and a communication mode (e.g., a voice communication, a text message) which correspond to the current state. For example, if the communication tool recommender 203 provides the current state of USER 1 105 and the communication tool corresponding to the state to a terminal of USER2 106, the terminal of the USER2 106 may be configured to display that USER1 105 is in conference and therefore may send a text message through a PDA so as not to interrupt the conference.

FIG. 3 illustrates an exemplary expanding profile 300.

Referring to FIG. 3, the expanding profile 300 includes a user profile 301 and terminal state data 302. The user profile 301 may include a user name, a user photo and a user ID. The terminal state data 302 may include the type of a terminal, an on and/or off state of a power supply, length of time and location in use, and applications in use. For convenience and illustration, the user profile 301 only includes the user ID in this exemplary profile.

The expanding profile may be collected and sent by each terminal to the server at regular intervals or whenever data is updated.

The expanding profile sent to the server may be stored and managed in the database. Since a user typically uses multiple terminals, the expanding profile 300 may be registered on a user ID basis.

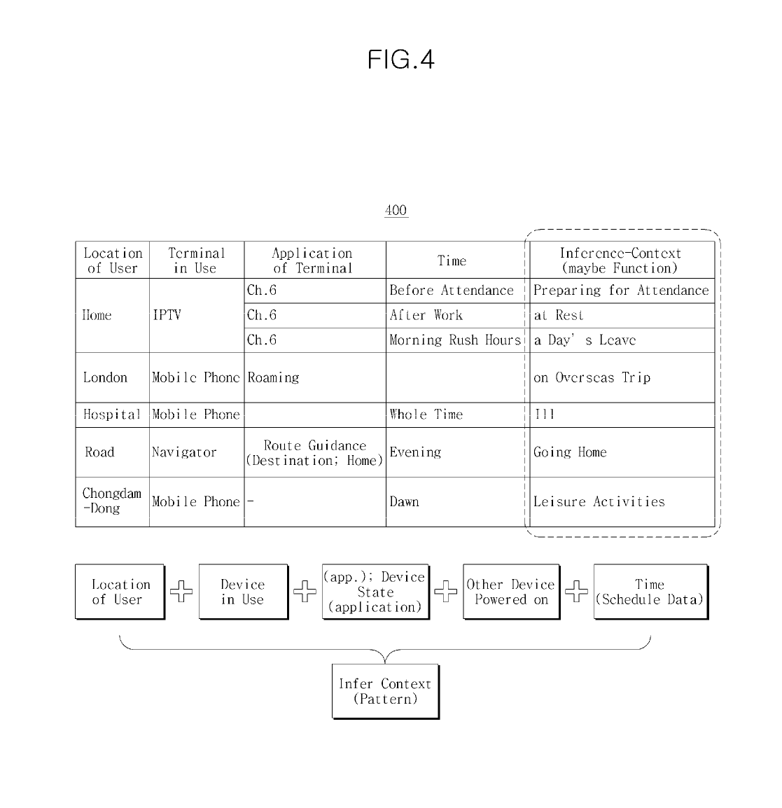

FIG. 4 illustrates how the context analyzer 202 may estimate a current state of a user.

Where a user is physically located at a business location (e.g., store, company, etc) and a schedule editor is running on the user's PDA at 10 am, the user may be estimated to be in a conference. That is, an exemplary state analysis table 400 shown in FIG. 4 may be obtained by making a statistical analysis of activities and organizing estimated situations.

The context analyzer 202 may include such a state analysis table 400. The context analyzer 202 may estimate current states by matching an expanding profile stored in the database 201 with each item of the state analysis table 400. For example, the context analyzer 202 may match a user's position, a type of a terminal in use, a condition of the terminal (an application in use), a terminal powered on, time, etc. with the state analysis table 400 to estimate a current state of the user.

The exemplary table shown in FIG. 4 may include items which may be assigned different weights, or may include a plurality of other algorithms. As another example, terminals may have their priorities in order. For example, a terminal powered on may have priority over a terminal which is powered off, or a terminal may have priority where an application is running on the terminal or the terminal is in use.

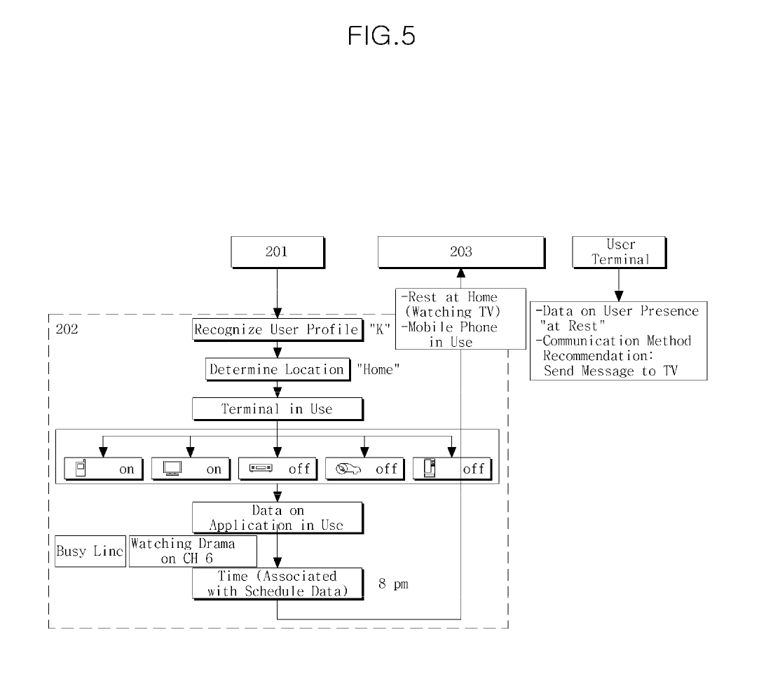

FIG. 5 illustrates an exemplary operation of the context analyzer 202 and the communication tool recommender 203.

Referring to FIG. 5, the context analyzer 202 identifies a user as ‘K’ from a user ID and determines a location of ‘K.’ Since in today's society many people own mobile phones, it will be assumed that the user possesses a user phone. Accordingly, a user's location may easily be determined from an expanding profile received from the mobile phone. For example, suppose that ‘K’ is determined to be at home. A terminal used by ‘K’ is then determined from data on an on and/or off state of a power supply in the expanding profile. Where the terminal in use is a mobile phone and an IPTV, an application running on the terminal may be determined. In FIG. 5, the mobile phone is in use and the IPTV is playing a program categorized as a “drama” on channel 6. The time is then determined when the terminal is in use. Accordingly, the context analyzer 202 may estimate that ‘K’ is ‘watching’ ‘TV’ at ‘home.’

The communication tool recommender 203 recommends a communication tool corresponding to the state based on the estimated state. In FIG. 5, since the context analyzer 202 has estimated that ‘K’ is ‘watching’ ‘TV’ at ‘home,’ the communication tool recommender 203 may select ‘Send a message to TV’ as a communication tool.

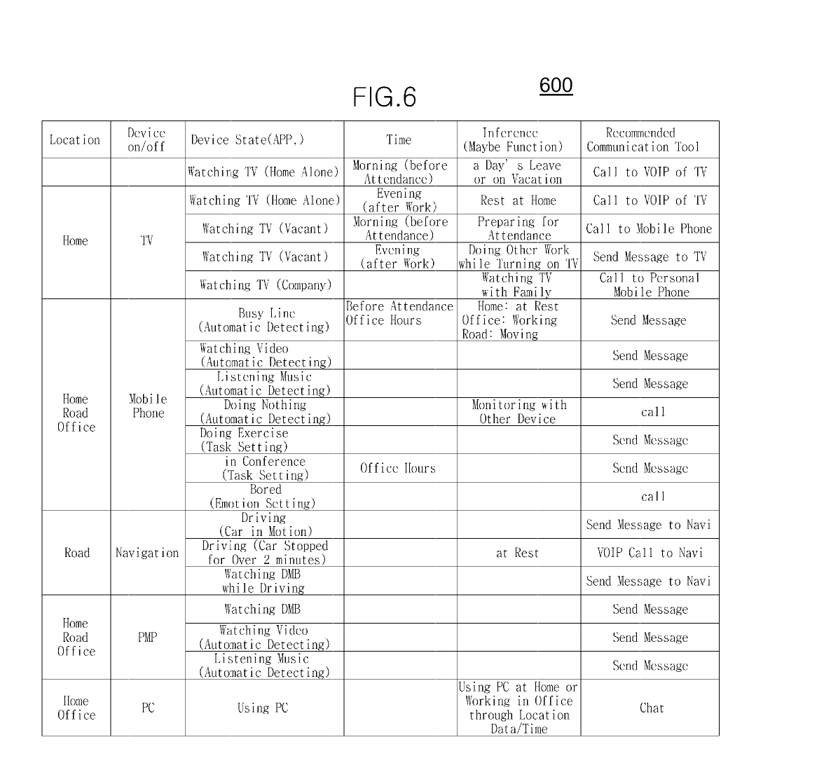

FIG. 6 illustrates an exemplary recommended communication tool table 600.

Referring to FIG. 6, an estimated current state is selected from the recommended communication tool table 600 and a corresponding communication tool is recommended, as described with reference to FIG. 4. However, the exemplary table illustrated in FIG. 6 may include other algorithms well known to one of ordinary skill in the art.

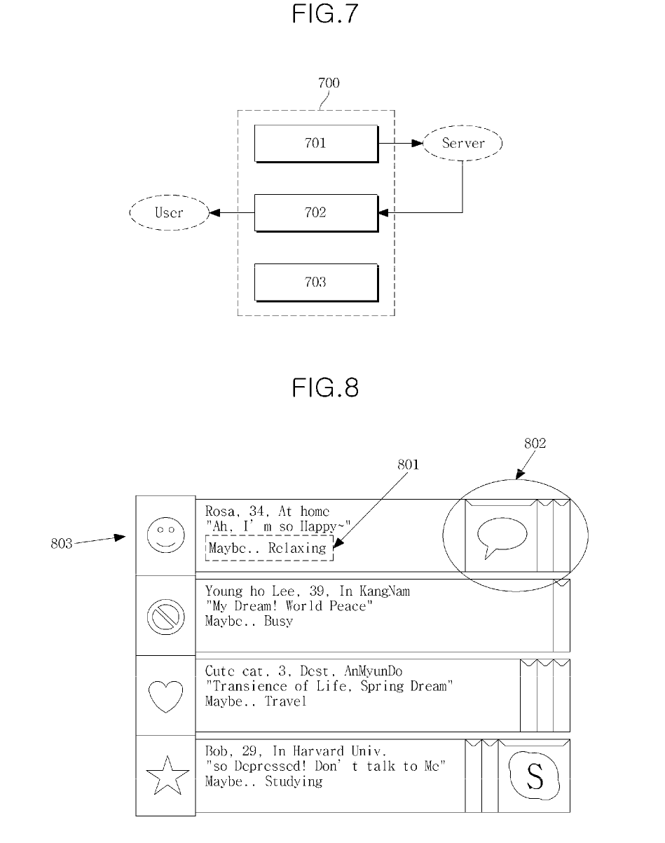

FIG. 7 illustrates an exemplary terminal 700.

Examples of the terminal 700 may include a mobile phone, an IPTV, a PMP, a PDA, a camera, an MP3 player, a navigator, and a personal computer.

Referring to FIG. 7, the exemplary terminal 700 includes a profile manager 701, a display 702 and a communicator 703.

The profile manager 701 collects and sends expanding profiles to the server 103. The expanding profile may include a user profile and state data of the terminal 700. Examples of the state data of the terminal 700 may include type of the terminal, an on and/or off of a power supply, a length of time and a location in use, and applications in use. The user profile may be directly entered by the user of the terminal 700. The state data of the terminal 700 may be entered from a sensor module. For example, the location may be determined from a GPS module of the terminal 700.

The display 702 may receive a current state of another terminal user and/or a recommended communication tool that corresponds to the state from the server 103 and display them to a user of the terminal 700. Other users (e.g., buddies) authorized to share data may be registered with the terminal 700. For example, an address list may be stored in a mobile phone. When displaying a buddy list to a user, the display 702 may display a current state of a corresponding buddy and a recommended communication tool in association with the buddy list. A method of providing a current state of a different terminal user and/or a recommended communication tool is described with reference to FIGS. 2 through 5.

The communicator 703 performs communication according to the communication tool selected by the user. When communicating with a different type of a terminal, the communicator 703 may convert a voice signal into a text or vice versa.

FIG. 8 illustrates an example of a screen on the display 702.

Referring to FIG. 8, the display 702 displays a list of buddies authorized to share data, together with current state data 801 of each buddy and recommended communication tool data 802 in association with the buddy list.

In FIG. 8, basic data 803 on each of the registered buddies may include photo, name, age, current location, mood, and current state data 801 of a corresponding buddy. Since the current state data 801 has been estimated from the expanding profile, expressions such as “Maybe...Relaxing,” “Maybe...Busy,” etc. may be displayed, as illustrated in FIG. 8.

The recommended communication tool data 802 may be configured such that terminals capable of communicating with a corresponding buddy are represented in different colors of bars and, where any bar is selected, an available communication mode is popped up.

Referring to basic data 803 (i.e., the data corresponding to Rosa), it can be seen from FIG. 8 that an IPTV, a mobile phone and a personal computer are in use and may be reached. If a user clicks on a bar indicating a mobile phone, the bar is expanded and the user can be connected with an available application for communication.

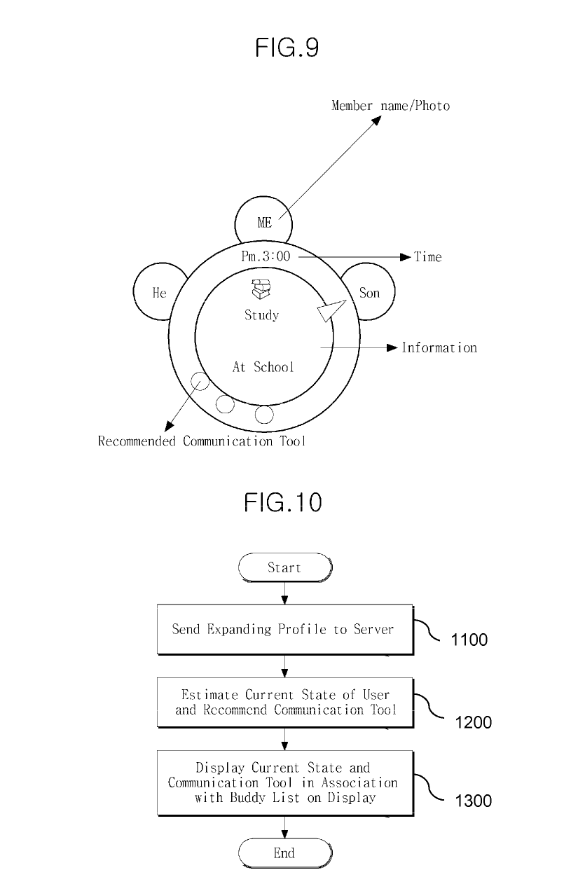

FIG. 9 illustrates another example of a screen on the display 702.

Referring to FIG. 9, a buddy list is presented in a widget style. For example, buddies or acquaintances may be grouped and arranged outside a circle. If one of the buddies is selected, that particular buddy's current state and a recommended communication tool may be displayed on the center of the circle.

FIG. 9 illustrates an example of a buddy list consisting of family members. If a son is selected to perform communication, his location and current state are displayed on the center of the circle in association with his schedule. At the same time, an available communication tool to reach him is displayed on a lower part of the circle. When the communication tool is selected, it is possible to reach a currently available terminal.

FIG. 10 is a flow chart illustrating an exemplary communication method.

Referring to FIG. 10, the communication method may be performed between a server and multiple terminals interconnected with each other over a network, as described above.

In operation 1100, a first terminal collects and sends its expanding profile to a server. The expanding profile may include a user profile and state data of a terminal of the user. For example, the expanding profile illustrated in FIG. 3 may be used.

In operation 1200, the server uses the expanding profile to estimate a current state of the first terminal and recommends a communication tool appropriate for the current state. The current state of the first terminal and the recommended communication tool may be sent to a second terminal. For example, the estimated current state and the recommended communication tool illustrated in FIGS. 2 through 6 may be used.

In operation 1300, the second terminal displays the current state of the first terminal and the recommended communication tool which are received from the server. For example, the screen illustrated in FIGS. 8 or 9 may be displayed on the second terminal.

As apparent from the above description, current states of a specific group of members may be estimated (e.g., a buddy list on a messenger) and a communication tool corresponding to the current states may be provided. Accordingly, quick and easy communication with each of the members may be performed.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication system, comprising:
a server; and
at least one terminal interconnected with the server over a network,
wherein the server estimates a current state of a user of a first terminal from an expanding profile received from the first terminal and recommends a communication tool corresponding to the current state, and
wherein a second terminal receives the current state of the user of the first terminal and a recommended communication tool from the server and displays the current state of the user of the first terminal and the recommended communication tool.

2. The communication system of claim 1, wherein the expanding profile comprises at least one of a personal profile of the user and state data of the first terminal.

3. The communication system of claim 2, wherein the state data comprises at least one of type of a terminal, an on and/or off state of a power supply, an application in use, and a length of time and/or a location in use.

4. The communication system of claim 1, wherein the first terminal is one of a mobile phone, an Internet protocol television (IPTV), a portable multimedia player (PMP), a personal digital assistant (PDA), a camera, an MP3 player, a navigator, and a personal computer (PC).

5. The communication system of claim 1, wherein terminals of the same user share the expanding profile in a same format.

6. A server interconnected with at least one terminal over a network, comprising:
a database to store an expanding profile received from the terminal;
a context analyzer configured to estimate a current state of a user of the terminal from the expanding profile; and
a communication tool recommender configured to recommend a communication tool corresponding to the current state based on the estimated current state.

7. The server of claim 6, wherein the expanding profile comprises at least one of a personal profile of the user and state data of the terminal.

8. The server of claim 7, wherein the state data comprises at least one of a type of a terminal, an on and/or off state of a power supply, an application in use, and a length of time and/or a location in use.

9. The server of claim 6, wherein the expanding profile is registered with the database based on a user.

10. The server of claim 6, wherein the server provides the estimated current state and the recommended communication tool to another terminal.

11. The server of claim 6, wherein the server provides the estimated current state and the recommended communication tool only to users designated as buddies authorized to share data.

12. A terminal interconnected with a server over a network, comprising:
a profile manager configured to collect and send an expanding profile to the server;
a display to receive a current state of a user of another terminal and a recommended communication tool corresponding to the current state from the server and display a list of buddies authorized to share data together with a current state of a corresponding buddy or a recommended communication tool in association with the buddy list; and
a communicator configured to perform communication according to a communication tool selected by a user of the terminal among the recommended communication tools.

13. The terminal of claim 12, wherein the terminal is one of a mobile phone, an Internet protocol television (IPTV), a portable multimedia player (PMP), a personal digital assistant (PDA), a camera, an MP3 player, a navigator, and a personal computer (PC).

14. The terminal of claim 12, wherein the expanding profile comprises at least one of a personal profile of the user of the terminal and state data of the terminal.

15. The terminal of claim 14, wherein the state data comprises at least one of a type of a terminal, an on and/or off state of a power supply, an application in use, and a length of time and/or a location in use.

16. The terminal of claim 12, wherein in response to performing communication according to the selected communication tool, the communicator converts a voice signal into a text or vice versa where different types of terminals are communicated with each other.

17. A communication method of a communication system including a server and at least one terminal interconnected with each other over a network, the method comprising:
collecting an expanding profile of a first terminal from the first terminal;
estimating a current state of a user of the first terminal from the expanding profile and recommending a communication tool corresponding to the estimated current state; and
providing the current state of the first terminal and the recommended communication tool to a second terminal.

18. The communication method of claim 17, wherein the user of the first terminal and a user of the second terminal are registered as buddies authorized to share data.

19. The communication method of claim 17, wherein the first terminal and/or the second terminal is/are one of a mobile phone, an Internet protocol television (IPTV), a portable multimedia player (PMP), a personal digital assistant (PDA), a camera, an MP3 player, a navigator, and a personal computer (PC).

20. The communication method of claim 17, wherein the expanding profile comprises at least one of a personal profile of the user of the first terminal and state data of the first terminal.

21. The communication method of claim 20, wherein the state data comprises a type of a terminal, an on and/or off state of a power supply, an application in use, and a length of time and/or a location in use.

22. A communication method of a communication system including a server and at least one terminal interconnected with each other over a network, the method comprising:
sending by a first terminal an expanding profile of the first terminal to the server; and
receiving by the first terminal a current state of a user of a second terminal, which is generated based on an expanding profile of the second terminal, and a recommended communication tool from the server, and displaying the received current state of the user and the recommended communication tool.

23. The communication method of claim 22, wherein in the displaying of the current state of the user, the first terminal displays a buddy list and the current state of the user of the second terminal and the recommended communication tool in association with the buddy list.
